(19) United States
(12) Patent Application Publication
(10) Pub. No.: US 2019/0131710 A1
(43) Pub. Date: May 2, 2019

(54) WIDEBAND CIRCULARLY POLARIZED ANTENNA

(71) Applicant: South China University of Technology, Guangzhou (CN)

(72) Inventors: Yong-Mei Pan, Guangzhou (CN); Wanjun Yang, Guangzhou (CN); Shaoyong Zheng, Guangzhou (CN); Pengfei Hu, Guangzhou (CN)

(21) Appl. No.: 15/885,763

(22) Filed: Jan. 31, 2018

(30) Foreign Application Priority Data
Oct. 30, 2017 (CN) 201711052571.X

(51) Int. Cl. H01Q 9/04; H01Q 9/28

(52) U.S. Cl. CPC H01Q 9/0428; H01Q 1/38; H01Q 9/285

(57) ABSTRACT

A wideband circularly polarized antenna, comprising a ground plane, a radiating element and a plurality of metallic plates; the radiating element is defined above the ground plane, the metallic plates are sequentially and vertically defined around the ground plane, and displacements from the metallic plates to the center of the ground plane are the same. The wideband circularly polarized antenna provided by the present invention has a broad bandwidth and a compact configuration.

### CROSS REFERENCE TO RELATED APPLICATIONS

The present application claims the benefit of Chinese Patent Application No. 201711052571.X filed on Oct. 30, 2017. All the above are hereby incorporated by reference.

### FIELD OF THE INVENTION

The present application relates to a technical field of microwave, and more particularly relates to a wideband circularly polarized antenna.

### BACKGROUND OF THE INVENTION

An antenna is an electronic device that can convert electric currents into radio waves or convert radio waves into electric currents. The antenna is typically used with radio transmitters or radio receivers and as part of a radio transmitting or receiving system. Antennas are widely used in systems such as radio, television, radar, mobile phones and satellite communications.

It is conventionally understood that antenna polarization refers to the electric field orientation of a radio wave that it radiates. There are two typical forms of the antenna polarization, a linearly polarized antenna and a circularly polarized antenna. For linearly polarized waves, the electric field of radio waves oscillates back and forth in one direction and the ability of an antenna to receive radio waves can be affected in this direction, which means that, there is polarization loss. Only when the polarization direction of the antenna is the same with the polarization direction of the radio wave, the radio wave can be received without any loss. In circular polarization, the electric field vector of a radio wave rotates circularly around a propagation axis at a radio frequency. Therefore, a circularly polarized antenna can reduce the loss caused by the misalignment of a transmitting antenna and a receiving antenna, and can suppress multipath effects caused by buildings and ground and is widely used in a global positioning system, a satellite communication and navigation system, a radio frequency identification system and so on.

At present, domestic and foreign researchers have done extensive research on wideband circularly polarized antennas. However, most of the wideband circularly polarized antennas proposed in prior literatures need to additionally introduce a power divider or a hybrid coupler for dual-feed or require a parasitic radiating element or a polarizer, these facilities inevitably increase complexity and size of an antenna system.

Therefore, it is urgent to propose a wideband circularly polarized antenna which has a compact configuration.

### SUMMARY OF THE INVENTION

The technical problem to be solved by the present invention is to provide a wideband circularly polarized antenna which has a compact configuration in light of the defects in the prior art.

Technical solution adopted by the invention to solve the technical problem is to provide a wideband circularly polarized antenna, comprising a ground plane, a radiating element and a plurality of metallic plates; the radiating element is defined above the ground plane, the metallic plates are sequentially and vertically defined around the ground plane, and displacements from the metallic plates to the center of the ground plane are the same.

In the wideband circularly polarized antenna provided in an embodiment of the present invention, the radiating element is a corner-truncated patch, the corner-truncated patch is defined above the ground plane.

In the wideband circularly polarized antenna provided in an embodiment of the present invention, the ground plane has a square shape, the corner-truncated patch is in a square shape with a pair of diagonal corners of the square cut off, the amount of the metallic plates is four, the metallic plates are sequentially and vertically arranged around the ground plane, and four metallic plates are not connected to each other.

In the wideband circularly polarized antenna provided in an embodiment of the present invention, the radiating element comprises two pairs of patch dipoles which are perpendicular to each other; the wideband circularly polarized antenna further comprises a substrate defined above the ground plane, the two pairs of patch dipoles are etched on the substrate.

In the wideband circularly polarized antenna provided in an embodiment of the present invention, each pair of patch dipoles respectively comprises two rectangular patch arms which are identical to each other, the two rectangular patch arms of each pair of the patch dipoles are respectively etched on the top surface and the bottom surface of the substrate, two rectangular patch arms on the same surface are connected by a vacant-quarter printed ring with circumference of λ_{g}/4, λ_{g} refers to guide wavelength, and two vacant-quarter printed rings with circumference of λ_{g}/4 are respectively soldered to the inner conductor and the outer conductor of a feed coaxial cable, the outer conductor of the feed coaxial cable is soldered to the ground plane.

In the wideband circularly polarized antenna provided in an embodiment of the present invention, the ground plane and the substrate are square shapes, the amount of the metallic plates is four, the metallic plates are sequentially and vertically arranged around the ground plane, and the four metallic plates are not connected to each other.

Another embodiment of the present invention provides a wideband circularly polarized antenna, comprises a ground plane, a corner-truncated patch and a plurality of metallic plates; the ground plane has a square shape, the corner-truncated patch is in a square shape with a pair of diagonal corners of the square cut off, the corner-truncated patch is defined above the ground plane, four metallic plates are sequentially and vertically arranged around the ground plane, displacements from the four metallic plates to the center of the ground plane are the same, and the four metallic plates are not connected to each other.

Another embodiment of the present invention provides a wideband circularly polarized antenna, comprises a ground plane, two pairs of patch dipoles which are perpendicular to each other, and a plurality of metallic plates; the wideband circularly polarized antenna further comprises a substrate defined above the ground plane, the ground plane and the substrate are square shapes; the two pairs of patch dipoles are etched on the substrate; each pair of patch dipoles respectively comprises two rectangular patch arms which are identical to each other, the two rectangular patch arms of each pair of the patch dipoles are respectively etched on the top surface and the bottom surface of the substrate, two rectangular patch arms on the same surface are connected by a vacant-quarter printed ring with circumference of λ_{g}/4, and two vacant-quarter printed rings with circumference of λ_{g}/4 are respectively soldered to the inner conductor and the outer conductor of a feed coaxial cable, the outer conductor of the feed coaxial cable is soldered to the ground plane; and the amount of the metallic plates is four, the metallic plates are sequentially and vertically arranged around the ground plane, and four metallic plates are not connected to each other.

The implementation of the wideband circularly polarized antenna provided by the present invention has following beneficial effects: orthogonal current is generated on metallic plates by vertically arranging the metallic plates around a simple circularly polarized antenna structure, so as to form an additional impedance passband and an additional axial radio passband near the original operating band, so as to greatly widen the bandwidth of the wideband circularly polarized antenna.

### BRIEF DESCRIPTION OF THE DRAWINGS

The present invention will be further described with reference to the accompanying drawings and embodiments in the following.

FIG. 1 is a schematic structural diagram of a wideband circularly polarized antenna according to a preferred embodiment of the present invention;

FIG. 2 is a top view of the wideband circularly polarized antenna of FIG. 1;

FIG. 3 is a diagram of simulated reflection coefficients comparing the wideband circularly polarized antenna (antenna II) shown in FIG. 1 with a circularly polarized antenna (antenna I) in the prior art;

FIG. 4 is a diagram of simulated axial ratios comparing the wideband circularly polarized antenna (antenna II) shown in FIG. 1 with a circularly polarized antenna (antenna I) in the prior art;

FIG. 5 is a side view of a wideband circularly polarized antenna according to another preferred embodiment of the present invention;

FIG. 6 is a top view of the wideband circularly polarized antenna shown in FIG. 5;

FIG. 7 is a diagram of simulated reflection coefficients comparing the wideband circularly polarized antenna (antenna III) shown in FIG. 5 with a circularly polarized antenna (antenna IV) in the prior art;

FIG. 8 is a diagram of simulated axial ratios comparing the wideband circularly polarized antenna (antenna III) shown in FIG. 5 with a circularly polarized antenna (antenna IV) in the prior art.

### DETAILED DESCRIPTION OF THE PREFERRED EMBODIMENT

To make a technical feature, objective and effect of the present application be understood more clearly, now a specific implementation of the present application is described in detail with reference to accompanying drawings and embodiments. The drawings show preferred embodiments of the invention. However, the present invention can be implemented in many different forms and is not limited to the embodiments described herein. Rather, these embodiments are provided so that this disclosure is thorough and complete.

It is important to note that when an element is referred to as being “fixed to” another element, it can be directly defined on the another element or intervening elements may also be present between the element and the another element. When an element is referred to as being “connected to” another element, the element may be connected directly to the another element or intervening elements may be present between the element and the another element at the same time. Terms “vertical,” “horizontal,” “left,” “right,” and the like as used herein are for illustrative purposes only.

Unless otherwise defined in the specification, all technical and scientific terms used herein have the same meaning as commonly understood by one of ordinary skill in the art to which this invention belongs. The terms used in the specification of the present invention are for the purpose of describing particular embodiments only, and are not intended to be limitations of the present invention. As used herein, the term “and/or” comprises any and all combinations of one or more of associated listed items.

The present invention provides a wideband circularly polarized antenna, comprising a ground plane, a radiating element and a plurality of metallic plates; the radiating element is defined above the ground plane, the metallic plates are sequentially and vertically defined around the ground plane, and the distance between one metallic plate and the ground plane is the same.

In the present invention, by vertically arranging the metallic plates around a simple circularly polarized antenna structure, orthogonal current is generated on the metallic plates to form an additional impedance passband and an additional axial radio passband near the original operating frequency band, so as to greatly broaden the bandwidth of the wideband circularly polarized antenna.

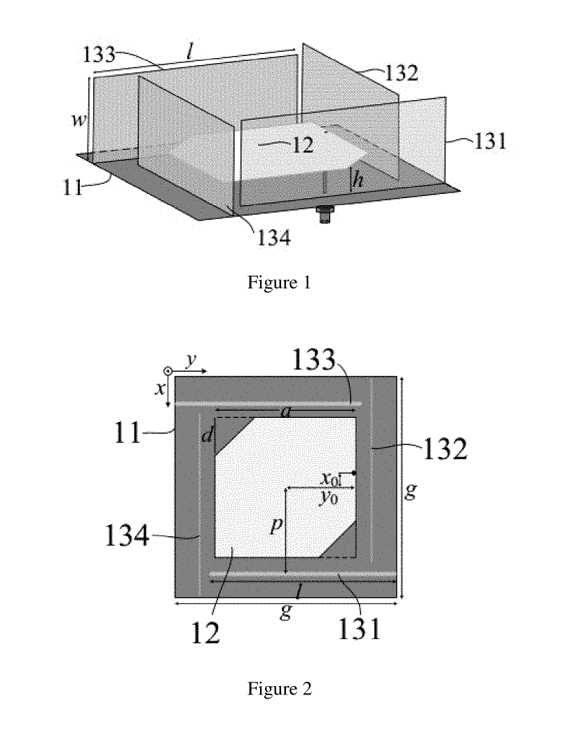

FIG. 1 and FIG. 2 are respectively a perspective structural view and a top view of a wideband circularly polarized antenna according to a preferred embodiment of the present invention. Referring to FIG. 1 and FIG. 2, in this embodiment, the wideband circularly polarized antenna 1 comprises a ground plane 11, a corner-truncated patch 12 and four metallic plates 131, 132, 133 and 134. The ground plane 11 has a square shape, the corner-truncated patch 12 is in a square shape with a pair of diagonal corners of the square cut off, the corner-truncated patch 12 is located above the ground plane 11, the metallic plates 131, 132, 133, and 134 are sequentially and vertically defined around the top surface of the ground plane 11, and displacements from each one plate of the metallic plates 131, 132, 133 and 134 to the center of the ground plane 11 are the same. It should be noted that the metallic plates 131, 132, 133 and 134 in the circularly polarized antenna should not be connected with each other, otherwise the antenna performance will be obviously deteriorated.

As shown in FIGS. 1-2, a side length of the corner-truncated patch 12 is a, the corner-truncated patch 12 is defined above the ground plane 11 with a height h, and a side length of the ground plane is g. Two triangular portions with side length d are removed from the diagonal corners of the corner-truncated patch 12, respectively. Based on this configuration, two orthogonal modes can be simultaneously excited by a single feed, and thus generating circularly polarized radiation with about 4% bandwidth. In order to enhance the bandwidth, four rectangular metallic plates 131, 132, 133, and 134 are sequentially defined on four sides of the ground plane 1, each plate of the metallic plates 131, 132, 133, and 134 has the same length 1, width w, respectively. The displacement from the metallic plates 131, 132, 133 and 134 to the center of the ground plane 11 is p. The circularly polarized antenna is asymmetrically fed with a feed coaxial probe located at (−x₀, y₀), radiating right-hand circularly polarized fields. Left-handed circularly polarized fields can be obtained by simply mirroring the corner-truncated patch, metallic plates and feed coaxial probe with respect to the x axis.

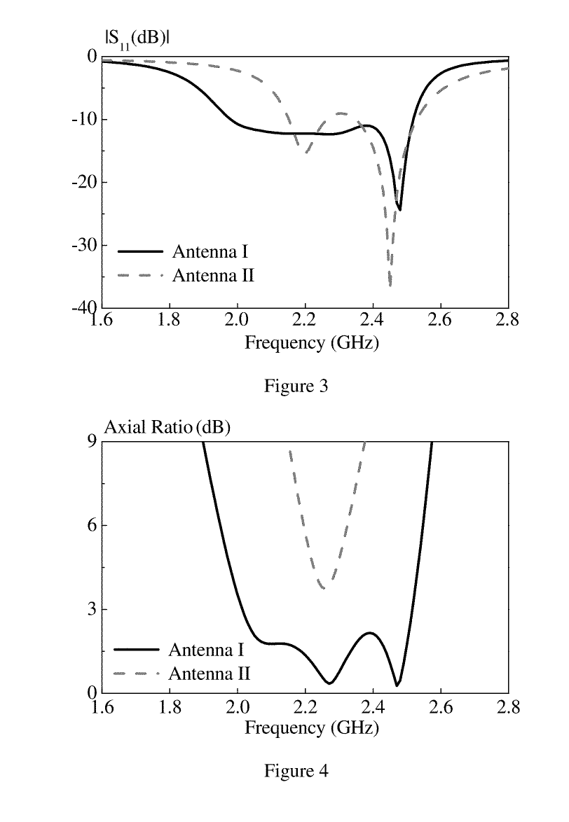

FIG. 3 is a diagram of simulated reflection coefficients comparing the wideband circularly polarized antenna (antenna II) shown in FIG. 1 with a circularly polarized antenna (antenna I) in the prior art; FIG. 4 is a diagram of simulated axial ratios comparing the wideband circularly polarized antenna (antenna II) shown in FIG. 1 with a circularly polarized antenna (antenna I) in the prior art. The antenna I is a conventional corner-truncated circularly polarized patch antenna without additional metallic plates, and the antenna II is a corner-truncated circularly polarized antenna according to a preferred embodiment of the present invention. It can be seen from simulation results in FIGS. 3-4 that the addition of the metallic plates 131, 132, 133, and 134 does not significantly affect the original operating bandwidth of the corner-truncated circularly polarized patch antenna but will create an additional impedance passband and an additional axial ratio passband, so that an enhanced bandwidth of 21.6% can be obtained.

When designing such a wideband circularly polarized antenna, a designer can design a corner-truncated patch antenna first and then adjust parameters a, d, h and feed position (−x₀, y₀) of the corner-truncated patch to obtain circularly polarized radiation at a required center frequency f₀. Second, four metallic plates are defined around the corner-truncated patch, initial dimensions of the metallic plates are l=a, w=0.25λ₀, and p=0.6a. Third, adjust l, w, p to obtain a required passband adjacent to the operating frequency band of the corner-truncated patch antenna. Finally, fine tune each of the parameters to get the best bandwidth.

It should be noted that besides a corner-truncated circularly-polarized antenna, the present invention can also be applied to other circularly polarized antennas, such as a U-slot circularly polarized antenna, a pin-loaded circularly polarized antenna, a stacked circularly polarized antenna. Certainly, in addition to these single-feed circularly polarized antennas, the present invention can also be applied to dual-feed circularly polarized antennas, even multi-feed circularly polarized antennas. The following will be a crossed-dipole circularly polarized antenna as an example for illustration.

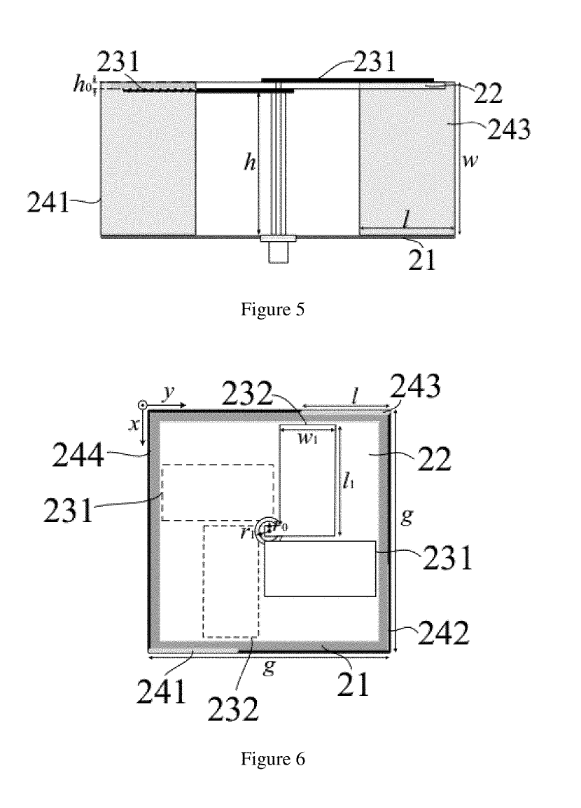

FIG. 5 and FIG. 6 are respectively a side view and a top view of a wideband circularly polarized antenna according to another preferred embodiment of the present invention. As shown in FIG. 5 and FIG. 6, in this embodiment, a wideband circularly polarized antenna 2 comprises a ground plane 21, two pairs of patch dipoles 231 and 232 which are perpendicular to each other, and four metallic plates 241, 242, 243, 244. The circularly polarized antenna 2 further comprises a substrate 22 defined above the ground plane 21. Both the ground plane 21 and the substrate 22 are square shapes. The two pairs of patch dipoles 231 and 232 are etched on the substrate 22. Each pair of patch dipoles 231 and 232 respectively comprises two rectangular patch arms which are identical to each other. The two rectangular patch arms of each pair of the patch dipoles 231 and 232 are respectively etched on the top surface and the bottom surface of the substrate 22. Two rectangular patch arms on the same surface are connected by a vacant-quarter printed ring with circumference of λ_{g}/4, λ_{g} refers to guide wavelength. The metallic plates 241, 242, 243 and 244 are sequentially and vertically defined around the ground plane 21, and the four metallic plates 241, 242, 243 and 244 are not connected to each other. Therein, the substrate 22 is located at a height h above the ground plane 21, a length of the rectangular patch arms is l₁, and a width is w₁.

Two vacant-quarter printed rings with circumference of λ_{g}/4 are respectively soldered to the inner conductor and the outer conductor of a feed coaxial cable. With this configuration, 90° phase difference is realized between crossed patch dipoles, resulting in circularly polarized radiation. The outer conductor of the feed coaxial cable also needs to be soldered to the ground plane 21, which is used as a reflector to provide unidirectional radiation.

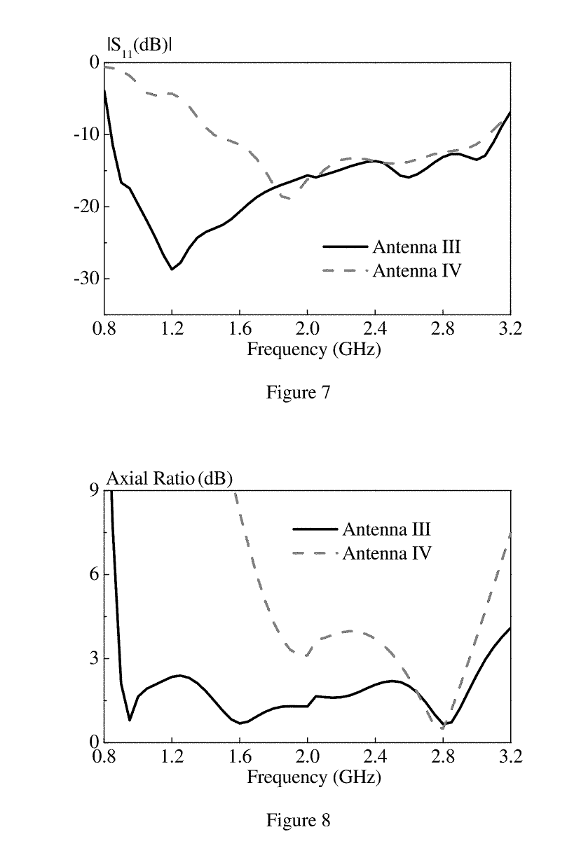

FIG. 7 is a diagram of simulated reflection coefficients comparing the circularly polarized antenna (antenna III) shown in FIG. 5 with a circularly polarized antenna (antenna IV) in the prior art; FIG. 8 is a diagram of simulated axial ratios comparing the circularly polarized antenna (antenna III) shown in FIG. 5 with a circularly polarized antenna (antenna IV) in the prior art. Therein, the antenna III is a conventional crossed-dipole circularly polarized antenna without vertical metallic plates, and the antenna IV is a crossed-dipole circularly polarized antenna according to a preferred embodiment of the present invention. It can be seen from simulation results of FIGS. 7-8 that a bandwidth of about 30% can be obtained by using a planar rectangular patch as dipole arms in a conventional crossed-dipole circularly polarized antenna of the prior art; in the preferred embodiment of the present invention, aiming at further enhancing the bandwidth, four rectangular metallic plates are sequentially added to corners of the ground plane 21, each metallic plate has a length l and a width w. Due to a strong coupling between crossed patch dipoles and vertical metallic plates, orthogonal current is produced, then impedance bandwidth and axial ratio bandwidth can be significantly enhanced. In this case, the bandwidth of an improved circularly polarized antenna with the metallic plates can be 106.1%. As phases of feeding signals are increased in a clockwise manner, the circularly polarized antenna generates left-handed circularly polarized fields. Right-hand circularly polarized fields can be obtained with reversed phase increment, i.e., by mirroring the crossed dipoles and vertical metallic plates with respect to the x axis.

When designing such a crossed-dipole wideband circularly polarized antenna, a designer can first design a traditional crossed-dipole antenna to cover an upper operating band, therein a dipole patch has a length l₁, a width w₁ and a height h. Second, four metallic plates are defined at corners of the ground plane, initial dimensions of the metallic plates are l=1.5w, w=h. Then, adjust the length of the dipole patch and the width of metallic plates to tune the response of a lower band, whereas adjust the width of the dipole patch to tune an upper band. Finally, refine each parameter to optimize the design for optimal bandwidth.

It can be understood that, each size parameter involved in this embodiment is only a case of a preferred embodiment, which should not be used as a condition for limiting a protection scope of the present invention, and the each size parameter may be correspondingly transformed according to actual requirements.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. A wideband circularly polarized antenna, comprising a ground plane, a radiating element and metallic plates; wherein the radiating element is defined above the ground plane, the metallic plates are sequentially and vertically defined around the ground plane, and displacements from the metallic plates to the center of the ground plane are the same.

2. The wideband circularly polarized antenna according to claim 1, wherein the radiating element is a corner-truncated patch, the corner-truncated patch is defined above the ground plane.

3. The wideband circularly polarized antenna according to claim 2, wherein the ground plane has a square shape, the corner-truncated patch is in a square shape with a pair of diagonal corners of the square cut off, the amount of the metallic plates is four, the metallic plates are sequentially and vertically arranged around the ground plane, and four metallic plates are not connected to each other.

4. The wideband circularly polarized antenna according to claim 1, wherein the radiating element comprises two pairs of patch dipoles which are perpendicular to each other; the wideband circularly polarized antenna further comprises a substrate defined above the ground plane, the two pairs of patch dipoles are etched on the substrate.

5. The wideband circularly polarized antenna according to claim 4, wherein each pair of patch dipoles respectively comprises two rectangular patch arms which are identical to each other, the two rectangular patch arms of each pair of the patch dipoles are respectively etched on the top surface and the bottom surface of the substrate, two rectangular patch arms on the same surface are connected by a vacant-quarter printed ring with circumference of λ_{g}/4, λ_{g} refers to guide wavelength, and two vacant-quarter printed rings with circumference of λ_{g}/4 are respectively soldered to the inner conductor and the outer conductor of a feed coaxial cable, the outer conductor of the feed coaxial cable is soldered to the ground plane.

6. The wideband circularly polarized antenna according claim 5, wherein the ground plane and the substrate are square shapes, the amount of the metallic plates is four, the metallic plates are sequentially and vertically arranged around the ground plane, and the four metallic plates are not connected to each other.

7. A wideband circularly polarized antenna, comprising a ground plane, a corner-truncated patch and metallic plates; wherein the ground plane has a square shape, the corner-truncated patch is in a square shape with a pair of diagonal corners of the square cut off, the corner-truncated patch is defined above the ground plane, four metallic plates are sequentially and vertically arranged around the ground plane, displacements from the four metallic plates to the center of the ground plane are the same, and the four metallic plates are not connected to each other.

8. A wideband circularly polarized antenna, comprising a ground plane, two pairs of patch dipoles perpendicular to each other, and metallic plates; wherein the circularly polarized antenna further comprises a substrate defined above the ground plane, the ground plane and the substrate are square shapes;
wherein the two pairs of patch dipoles are etched on the substrate;
wherein each pair of patch dipoles respectively comprises two rectangular patch arms which are identical to each other, the two rectangular patch arms of each pair of the patch dipoles are respectively etched on the top surface and the bottom surface of the substrate, two rectangular patch arms on the same surface are connected by a vacant-quarter printed ring with circumference of λ_{g}/4, and two vacant-quarter printed rings with circumference of λ_{g}/4 are respectively soldered to the inner conductor and the outer conductor of a feed coaxial cable, the outer conductor of the feed coaxial cable is soldered to the ground plane; and
wherein the amount of the metallic plates is four, the metallic plates are sequentially and vertically arranged around the ground plane, and four metallic plates are not connected to each other.
